(19) United States
(12) Patent Application Publication
(10) Pub. No.: US 2024/0216796 A1
(43) Pub. Date: Jul. 4, 2024

(54) DATA PROCESSING METHOD AND DEVICE OF GAMEPAD AND GAME SYSTEM

(71) Applicant: AAC Acoustic Technologies (Shanghai) Co., Ltd., Shanghai (CN)

(72) Inventor: Kun Gao, Shanghai (CN)

(21) Appl. No.: 18/321,731

(22) Filed: May 22, 2023

Related U.S. Application Data
(63) Continuation of application No. PCT/CN2023/072781, filed on Jan. 18, 2023.

(30) Foreign Application Priority Data
Dec. 29, 2022 (CN) 202211715818.2

(51) Int. Cl. A63F 13/285; A63F 13/22

(52) U.S. Cl. CPC A63F 13/285; A63F 13/22

(57) ABSTRACT

The disclosed is a data processing method of a gamepad, including: acquiring a configuration parameter of the gamepad, the configuration parameter including a maximum transmission unit (MTU) value for communication with the gamepad, acquiring a vibration signal to be transmitted, splitting the vibration signal to be transmitted into a plurality of sub-signals according to the configuration parameter, and generating a corresponding transmission time point for each of the plurality of sub-signals, each of the plurality of sub-signals having a size not greater than the MTU value; and transmitting the plurality of sub-signals to the gamepad in sequence according to an order of transmission time points of the plurality of sub-signals. In this way, a complicated vibration signal with a long duration can be transmitted to the gamepad, which improves vibration experience.

### CROSS REFERENCE TO RELATED APPLICATIONS

This application is a continuation of PCT Patent Application No. PCT/CN2023/072781 entitled “DATA PROCESSING METHOD AND DEVICE OF GAMEPAD AND GAME SYSTEM,” filed Jan. 18, 2023, which claims priority to Chinese Patent Application No. CN 202211715818.2, entitled “DATA PROCESSING METHOD AND DEVICE OF GAMEPAD AND GAME SYSTEM,” filed on Dec. 29, 2023, which is incorporated herein by reference in its entirety.

### TECHNICAL FIELD

The present disclosure relates to the technical field of motor vibration in a gamepad, and in particular, to a data processing method and device of a gamepad and a game system.

### BACKGROUND

Currently, a game host generally transmits short vibration signals to a gamepad. Contents of the vibration signals are as simple as only including information like duration and intensity of vibration. Vibration signals of long duration that are complicated and that include information containing frequency curves usually cannot be transmitted, because of limitations in a bandwidth of communication between the game host and the gamepad and a maximum transmission unit (hereinafter MTU). As a result, vibration effect of the gamepad is monotonous, vibration ends after only a short period of time, and vibration experience is poor.

Therefore, it is desired to provide a new data processing method of the gamepad to solve the above technical problem.

### SUMMARY

The objective of the present disclosure is to provide a data processing method of a gamepad that can transmit complicated vibration signals with long duration to the gamepad and improve vibration experience.

In order to achieve the objective, in one aspect, the present disclosure provides a data processing method of a gamepad, including:
acquiring a configuration parameter of the gamepad, the configuration parameter including an MTU value for communication with the gamepad;
acquiring a vibration signal to be transmitted;
splitting the vibration signal to be transmitted into a plurality of sub-signals according to the configuration parameter, and generating a corresponding transmission time point for each of the plurality of sub-signals, each of the plurality of sub-signals having a size not greater than the MTU value; and
transmitting the plurality of sub-signals to the gamepad in sequence according to an order of transmission time points of the plurality of sub-signals.

As an improvement, the operation of splitting the vibration signal to be transmitted into the plurality of sub-signals according to the configuration parameter includes:
splitting the vibration signal to be transmitted into the plurality of sub-signals according to a rule that each of the plurality of sub-signals has a size not greater than the MTU value and a difference between the MTU value and the size of each of the plurality of sub-signals is less than a preset threshold.

As an improvement, the data processing method of the gamepad further includes:
determining, after acquiring the vibration signal to be transmitted, whether the vibration signal to be transmitted has a size greater than the MTU value; and
implementing the operation of splitting the vibration signal to be transmitted into the plurality of sub-signals according to the configuration parameter, in response to the vibration signal to be transmitted having the size greater than the MTU value.

As an improvement, the configuration parameter further includes a cache capacity of the gamepad, and the operation of splitting the vibration signal to be transmitted into the plurality of sub-signals according to the configuration parameter includes:
determining whether the vibration signal to be transmitted has a size greater than the cache capacity;
removing, in response to the vibration signal to be transmitted having the size greater than the cache capacity, a part of the vibration signal to be transmitted so that a remaining part of the vibration signal to be transmitted has a size not greater than the cache capacity; and
splitting the remaining part of the vibration signal to be transmitted into the plurality of sub-signals according to the MTU value.

As an improvement, the configuration parameter further includes a cache capacity of the gamepad, and the data processing method further includes:
determining, after acquiring the vibration signal to be transmitted, whether the vibration signal to be transmitted has a size greater than the cache capacity; and
transmitting an instruction of clearing cache to the gamepad at intervals with a preset duration during a process of transmitting the plurality of sub-signals to the gamepad, in response to the vibration signal to be transmitted having the size greater than the cache capacity.

As an improvement, the configuration parameter further includes a signal format supported by the gamepad, and the operation of splitting the vibration signal to be transmitted into the plurality of sub-signals according to the configuration parameter includes:
determining whether a format of the vibration signal to be transmitted is consistent with the signal format supported by the gamepad;
converting the format of the vibration signal to be transmitted to the signal format supported by the gamepad, in response to the format of the vibration signal to be transmitted being not consistent with the signal format supported by the gamepad; and
splitting a converted vibration signal to be transmitted into the plurality of sub-signals according to the MTU value.

As an improvement, the operation of acquiring the configuration parameter of the gamepad includes:
transmitting a query instruction to the gamepad; and
receiving information carrying a configuration parameter returned by the gamepad according to the query instruction.

In a second aspect, the present disclosure further provides a data processing device of a gamepad, including:
a first acquiring module, configured to acquire a configuration parameter of the gamepad, the configuration parameter including an MTU value for communication with the gamepad;
a second acquiring module, configured to acquire a vibration signal to be transmitted;
a splitting module, configured to split the vibration signal to be transmitted into a plurality of sub-signals according to the configuration parameter, and generate a corresponding transmission time point for each of the plurality of sub-signals, each of the plurality of sub-signals having a size not greater than the MTU value; and
a transmission module, configured to transmit the plurality of sub-signals to the gamepad in sequence according to an order of transmission time points of the plurality of sub-signals.

In a third aspect, the present disclosure further provides a game system including a gamepad and a data processing device in communicative connection with the gamepad, the data processing device being the data processing device as described above.

In a fourth aspect, the present disclosure further provides a computer-readable storage medium storing a computer program. The computer program, when executed by a processor, implements operations of the data processing method of the gamepad as described above.

Compared with a related technology, in the data processing method of the gamepad of the present disclosure, the vibration signal to be transmitted is split into a plurality of sub-signals, and a corresponding transmission time point is generated for each of the plurality of sub-signals. Herein, each of the plurality of sub-signals has a size not greater than the MTU value for communication with the gamepad. Then, the plurality of sub-signals are transmitted to the gamepad in sequence according to an order of transmission time points of the plurality of sub-signals. In this way, a complicated (e.g., including a frequency curve) vibration signal with a long duration is split into a plurality of sub-signals and transmitted to the gamepad. This not only meets an MTU requirement of the gamepad, but an entire complicated vibration signal with a long duration can be transmitted to the gamepad, so that the gamepad can acquire diversified vibration effects, and a vibration sense with longer duration of vibration can be acquired, which improves vibration experience.

### BRIEF DESCRIPTION OF DRAWINGS

In order to illustrate the technical solutions in the embodiments of the present disclosure more clearly, the drawings used in the description of the embodiments will be briefly described below. It is apparent that the drawings in the following description are only some embodiments of the present disclosure. For those skilled in the art, other drawings may also be obtained in accordance with the drawings without any inventive effort.

FIG. 1 is a schematic diagram showing a scene of a data processing method provided in an embodiment of the present disclosure.

FIG. 2 is a flow chart of a data processing method provided in an embodiment of the present disclosure.

FIG. 3 is another flow chart of a data processing method provided in an embodiment of the present disclosure.

FIG. 4 is a signal interaction timing diagram of the data processing method in FIG. 3.

FIG. 5 is yet another flow chart of a data processing method provided in an embodiment of the present disclosure.

FIG. 6 is an additional flow chart of a data processing method provided in an embodiment of the present disclosure.

FIG. 7 is one more flow chart of a data processing method provided in an embodiment of the present disclosure.

FIG. 8 is a structural diagram of a data processing device provided in an embodiment of the present disclosure.

FIG. 9 is another structural diagram of a data processing device provided in an embodiment of the present disclosure.

FIG. 10 is still another structural diagram of a data processing device provided in an embodiment of the present disclosure.

### DETAILED DESCRIPTION OF EMBODIMENTS

Technical solutions in embodiments of the present disclosure will be clearly and completely described with reference to accompany drawings of the present disclosure. Obviously, the described embodiments are only some embodiments rather than all embodiments of the present disclosure. Based on the embodiments of the present disclosure, all other embodiments obtained by persons skilled in the art without making any creative efforts fall into the protection scope of the present disclosure.

Embodiments of the present disclosure provide a data processing method and device of a gamepad and a game system.

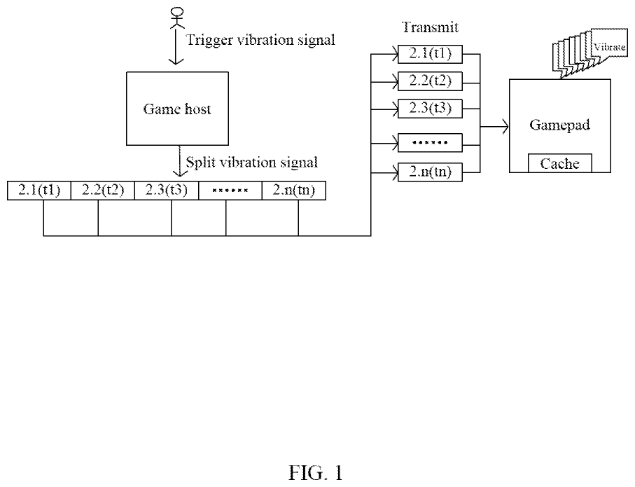

FIG. 1 is a schematic diagram showing a scene of a data processing method of a gamepad provided in an embodiment of the present disclosure. The data processing method is applicable to a game host. The game host may first acquire a configuration parameter of the gamepad. The configuration parameter includes, for example, an MTU value for communication with the gamepad. The game host acquires a vibration signal to be transmitted triggered by a user, and then splits the vibration signal to be transmitted into a plurality of sub-signals according to the configuration parameter. For example, the game host splits the vibration signal to be transmitted into the plurality of sub-signals, each of which has a size not greater than the MTU value, according to the MTU value. That is, each of the plurality of sub-signals has a size not greater than the MTU value, and a corresponding transmission time point is generated for each of the plurality of sub-signals. As shown in FIG. 1, it is taken as an example that a vibration signal to be transmitted is split into n sub-signals. The vibration signal to be transmitted is split into a sub-signal 2.1 (with a transmission time point of t1), a sub-signal 2.2 (with a transmission time point of t2), a sub-signal 2.3 (with a transmission time point of t3), . . . , a sub-signal 2.n (with a transmission time point of tn). Accordingly, the vibration signal to be transmitted is converted to a sequence including a plurality of two-tuples. Each of the plurality of two-tuples includes a vibration signal and a transmission time point of the vibration signal. Then the n sub-signals are transmitted in sequence to the gamepad according to an order of transmission time points of the n sub-signals. That is, the sub-signal 2.1 is transmitted at the time point of t1, the sub-signal 2.2 is transmitted at the time point of t2, and the sub-signal 2.3 is transmitted at the time point of t3, and so on, until the sub-signal 2.n is transmitted at the time point of tn. Accordingly, each time the gamepad receives a sub-signal, the gamepad controls a motor to vibrate according to the sub-signal received.

Therefore, when the vibration signal to be transmitted is complicated (e.g., including a frequency curve), has a long duration, and has a size greater than the MTU value, based on the data processing method in the present disclosure, the vibration signal to be transmitted is split into a plurality of sub-signals, each of which has a size not greater than the MTU value. The plurality of sub-signals are transmitted one by one. This not only meets an MTU requirement of the gamepad, but an entire complicated vibration signal with a long duration can be transmitted to the gamepad, so that the gamepad can acquire diversified vibration effects, and a vibration sense with longer duration of vibration can be acquired, which improves vibration experience.

The present disclosure is further described as follows.

This embodiment is described from a prospective of a data processing device that may be assembled in a game host.

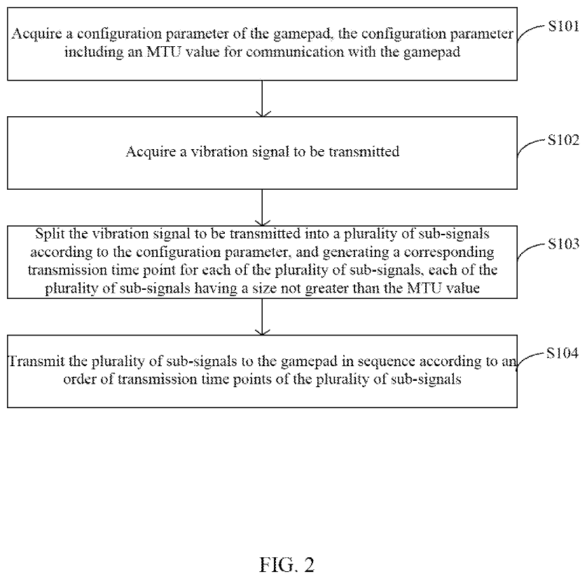

With reference to FIG. 2, the data processing method of the gamepad in this embodiment includes the following operations.

In S101, a configuration parameter of the gamepad is acquired. The configuration parameter includes an MTU value for communication with the gamepad.

For example, a query instruction may be transmitted to the gamepad, so that the gamepad feeds back its configuration parameter according the query instruction. Upon receiving information carrying the configuration parameter returned by the gamepad, the configuration parameter of the gamepad may be acquired. The configuration parameters of the gamepad may include, for example, a signal format supported by the gamepad, the MTU value and a cache capacity of the gamepad.

In S102, the vibration signal to be transmitted is acquired.

The vibration signal to be transmitted may be, for example, triggered by the user through triggering a vibration function key during game playing of the user.

In S103, the vibration signal to be transmitted is split into a plurality of sub-signals according to the configuration parameter, and a corresponding transmission time point for each of the plurality of sub-signals is generated. Each of the plurality of sub-signals has a size not greater than the MTU value.

More specifically, the operation of splitting the vibration signal to be transmitted into the plurality of sub-signals according to the configuration parameter is as follows. The vibration signal to be transmitted is split into the plurality of sub-signals, each of which has a size not greater than the MTU value, according to the MTU value. That is, each of the plurality of sub-signals has a size not greater than the MTU value, and a corresponding transmission time point is generated for each of the plurality of sub-signals. As shown in FIG. 1, the vibration signal to be transmitted is split into a sub-signal 2.1 (with a transmission time point of t1), a sub-signal 2.2 (with a transmission time point of t2), a sub-signal 2.3 (with a transmission time point of t3), . . . , a sub-signal 2.n (with a transmission time point of tn). Accordingly, the vibration signal to be transmitted is converted to a sequence including a plurality of two-tuples. Each of the plurality of two-tuples includes a vibration signal and a transmission time point of the vibration signal.

In S104, the plurality of sub-signals are transmitted to the gamepad in sequence according to an order of transmission time points of the plurality of sub-signals.

That is, the sub-signal 2.1 is transmitted at the time point of t1, the sub-signal 2.2 is transmitted at the time point of t2, and the sub-signal 2.3 is transmitted at the time point of t3, and so on, until the sub-signal 2.n is transmitted at the time point of tn. Accordingly, each time the gamepad receives a sub-signal, the gamepad controls a motor to vibrate according to the sub-signal received.

Therefore, when the vibration signal to be transmitted is complicated (e.g., including a frequency curve), has a long duration, and has a size greater than the MTU value, based on the data processing method in the present disclosure, the vibration signal to be transmitted is split into a plurality of sub-signals, each of which has a size not greater than the MTU value. The plurality of sub-signals are transmitted one by one. This not only meets an MTU requirement of the gamepad, but an entire complicated vibration signal with a long duration can be transmitted to the gamepad, so that the gamepad can acquire diversified vibration effects, and a vibration sense with longer duration of vibration can be acquired, which improves vibration experience.

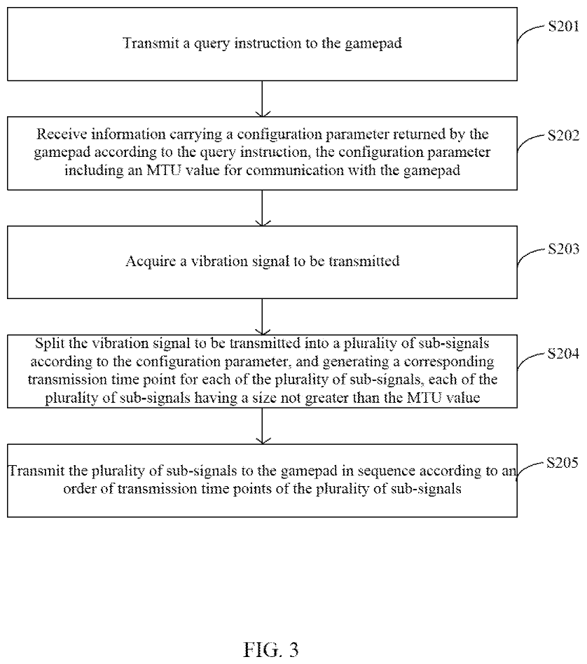

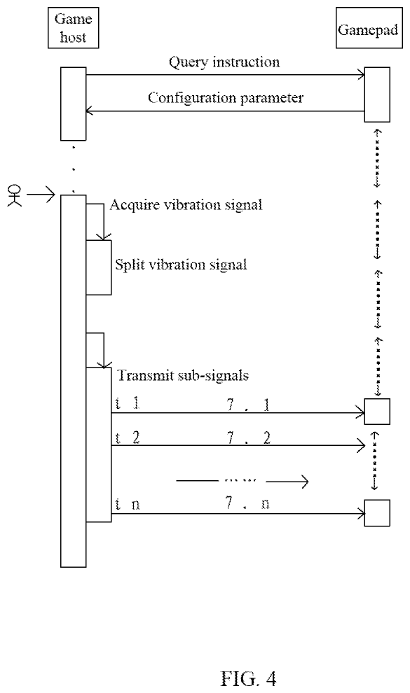

With reference to FIG. 3 and FIG. 4, a data processing method of a gamepad in another embodiment of the present disclosure includes the following operations.

In S201, a query instruction is transmitted to the gamepad.

In S202, information carrying a configuration parameter returned by the gamepad according to the query instruction is received. The configuration parameter includes an MTU value for communication with the gamepad.

Accordingly, through the operations, the configuration parameter of the gamepad may be acquired. Alternatively, in another embodiment, configuration parameters of gamepads of multiple types may be pre-stored in advance, so that the gamepads may return type information of the gamepads to the game host after receiving query instructions. The game host finds configuration information of a gamepad of a corresponding type from pre-stored configuration information according to type information of the gamepad received. Alternatively, the game host may search for the configuration information of the gamepad of the corresponding type from a network according to the type information returned by the gamepad.

In S203, a vibration signal to be transmitted is acquired.

The vibration signal to be transmitted may be, for example, triggered by the user through triggering a vibration function key during game playing of the user.

In S204, the vibration signal to be transmitted is split into a plurality of sub-signals according to the configuration parameter, and a corresponding transmission time point for each of the plurality of sub-signals is generated. Each of the plurality of sub-signals has a size not greater than the MTU value.

For example, as shown in FIG. 4, the vibration signal to be transmitted is split into a sub-signal 7.1 (with a transmission time point of t1), a sub-signal 7.2 (with a transmission time point of t2), a sub-signal 7.3 (with a transmission time point of t3), . . . , a sub-signal 7.n (with a transmission time point of tn).

In S205, the plurality of sub-signals are transmitted to the gamepad in sequence according to an order of transmission time points of the plurality of sub-signals.

That is, the sub-signal 7.1 is transmitted at the time point of t1, the sub-signal 7.2 is transmitted at the time point of t2, and the sub-signal 7.3 is transmitted at the time point of t3, and so on, until the sub-signal 7.n is transmitted at the time point of tn. Accordingly, each time the gamepad receives a sub-signal, the gamepad controls a motor to vibrate according to the sub-signal received.

Further, in embodiments of the present disclosure, the operation of splitting the vibration signal to be transmitted into the plurality of sub-signals according to the configuration parameter includes: splitting the vibration signal to be transmitted into the plurality of sub-signals according to a rule that each of the plurality of sub-signals has a size not greater than the MTU value and a difference between the MTU value and the size of each of the plurality of sub-signals is less than a preset threshold.

It should be understood that the less the preset threshold is set, the less the difference between the size of the respective sub-signal and the MTU value is, and the closer the size of the respective sub-signal is to the MTU value. Accordingly, in a case where a requirement for MTU is met, the size of the respective sub-signal may be as great as possible, so that the sub-signal may take as much part of the entire vibration signal to be transmitted as possible. In this way, the transmission efficiency can be improved.

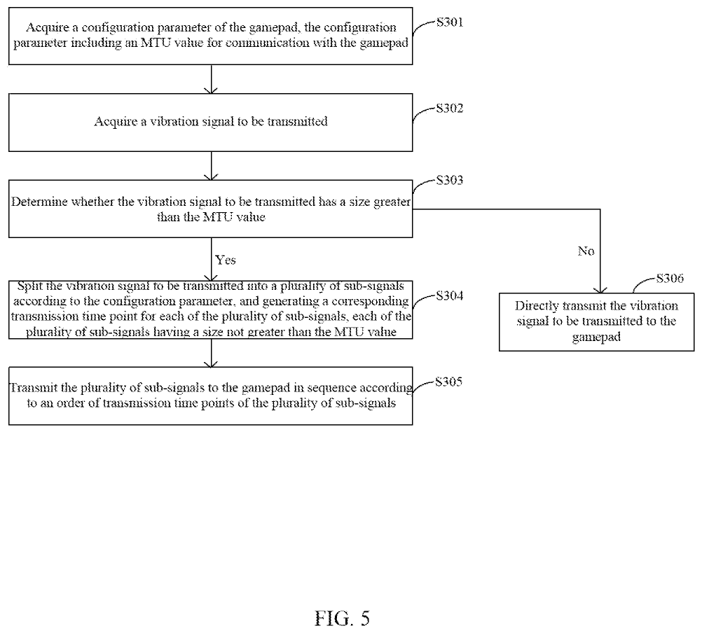

With reference to FIG. 5, a data processing method of a gamepad in another embodiment of the present disclosure includes the following operations.

In S301, a configuration parameter of the gamepad is acquired. The configuration parameter includes an MTU value for communication with the gamepad.

In S302, a vibration signal to be transmitted is acquired.

In S303, it is determined whether the vibration signal to be transmitted has a size greater than the MTU value.

In S304, the vibration signal to be transmitted is split into the plurality of sub-signals according to the configuration parameter when the vibration signal to be transmitted has the size greater than the MTU value. Besides, a corresponding transmission time point is generated for each of the plurality of sub-signals. Each of the plurality of sub-signals has a size not greater than the MTU value.

In S305, the plurality of sub-signals are transmitted to the gamepad in sequence according to an order of transmission time points of the plurality of sub-signals.

In S306, if the vibration signal to be transmitted has a size not greater than the MTU value, the vibration signal to be transmitted is directly transmitted to the gamepad.

It is determined first whether the vibration signal to be transmitted has a size greater than the MTU value. If yes, the entire vibration signal to be transmitted cannot be transmitted at a time, and thus the vibration signal to be transmitted is split. Otherwise, the entire vibration signal to be transmitted can be transmitted at a time. Therefore, the vibration signal to be transmitted is directly transmitted to the gamepad to improve transmission efficiency.

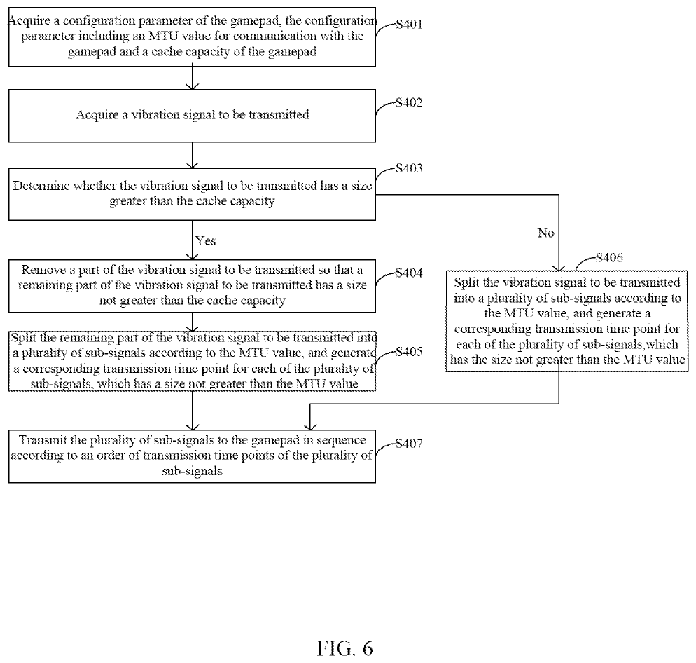

With reference to FIG. 6, a data processing method of a gamepad in another embodiment of the present disclosure includes the following operations.

In S401, a configuration parameter of the gamepad is acquired. The configuration parameter includes an MTU value for communication with the gamepad and a cache capacity of the gamepad.

In S402, a vibration signal to be transmitted is acquired.

In S403, it is determined whether the vibration signal to be transmitted has a size greater than the cache capacity.

In S404, if the vibration signal to be transmitted has the size greater than the cache capacity, a part of the vibration signal to be transmitted is removed so that a remaining part of the vibration signal to be transmitted has a size not greater than the cache capacity.

By removing part of the vibration signal to be transmitted, the vibration signal transmitted may meet a cache requirement of the gamepad. Herein, the removed part may be, for example, a signal of a front part of the vibration signal to be transmitted, or may be a signal at an end portion, which is not defined.

In S405, the remaining part of the vibration signal to be transmitted is split into a plurality of sub-signals according to the MTU value. A corresponding transmission time point is generated for each of the plurality of sub-signals. Each of the plurality of sub-signals has a size not greater than the MTU value.

In S406, if the vibration signal to be transmitted has the size not greater than the cache capacity, the vibration signal to be transmitted is split into a plurality of sub-signals according to the MTU value, and a corresponding transmission time point is generated for each of the plurality of sub-signals. Each of the plurality of sub-signals has the size not greater than the MTU value.

In S407, the plurality of sub-signals are transmitted to the gamepad in sequence according to an order of transmission time points of the plurality of sub-signals.

This embodiment can enable the entire vibration signal transmitted to meet the cache requirement of the gamepad.

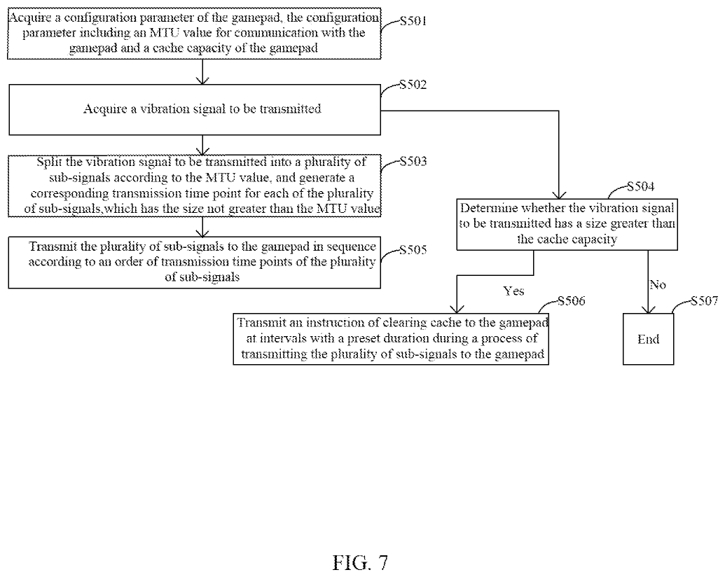

With reference to FIG. 7, a data processing method of a gamepad in another embodiment of the present disclosure includes the following operations.

In S501, a configuration parameter of the gamepad is acquired. The configuration parameter includes an MTU value for communication with the gamepad and a cache capacity of the gamepad.

In S502, a vibration signal to be transmitted is acquired.

In S503, the vibration signal to be transmitted is split into the plurality of sub-signals according to the configuration parameter. Besides, a corresponding transmission time point is generated for each of the plurality of sub-signals. Each of the plurality of sub-signals has a size not greater than the MTU value.

In S504, it is determined whether the vibration signal to be transmitted has a size greater than the cache capacity.

In S505, the plurality of sub-signals are transmitted to the gamepad in sequence according to an order of transmission time points of the plurality of sub-signals.

In S506, if the vibration signal to be transmitted has the size greater than the cache capacity, an instruction of clearing cache is transmitted to the gamepad at intervals with a preset duration during a process of transmitting the plurality of sub-signals to the gamepad.

In S507, if the vibration signal to be transmitted has a size not greater than the cache capacity, the determining procedure ends.

In this embodiment, when the vibration signal to be transmitted has the size greater than the cache capacity of the gamepad, the instruction of clearing cache may be transmitted to the gamepad at intervals with the preset duration. After the gamepad receives the instruction of clearing cache, a sub-signal completing a vibration response may be cleared from the cache, so as to leave a cache space to cache a subsequently received sub-signal. Therefore, in this way, the gamepad can receive the entire vibration signal so that the cache meets what is required.

It should be understood that for a gamepad having a function of automatically clearing cache, the instruction of clearing cache may not be transmitted. Through the function of automatically clearing cache of the gamepad, the cache of the gamepad can meet a storage requirement.

In some embodiments of the present disclosure, the configuration parameter of the gamepad may further include a signal format supported by the gamepad. Herein, the operation of splitting the vibration signal to be transmitted into the plurality of sub-signals according to the configuration parameter includes: determining whether a format of the vibration signal to be transmitted is consistent with the signal format supported by the gamepad, converting the format of the vibration signal to be transmitted to the signal format supported by the gamepad if the format of the vibration signal to be transmitted is not consistent with the signal format supported by the gamepad, and splitting a converted vibration signal to be transmitted into the plurality of sub-signals according to the MTU value. Herein, if the format of the vibration signal to be transmitted is consistent with the signal format supported by the gamepad, it is not necessary to perform format conversion on the vibration signal to be transmitted. The operation of splitting the vibration signal to be transmitted into the plurality of sub-signals according to the MTU value may be directly performed. In this way, the sub-signals transmitted can meet requirement of the gamepad to the signal format.

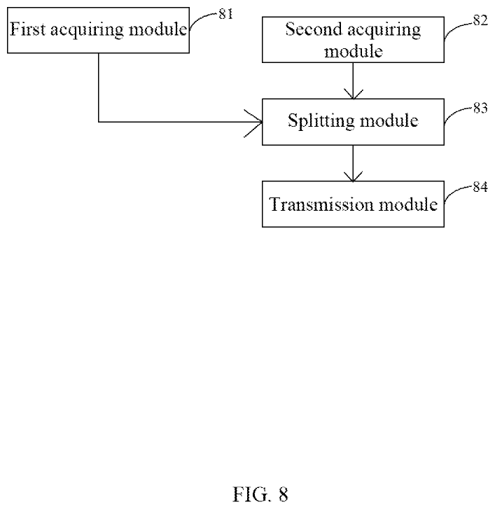

An embodiment of the present disclosure further provides a data processing device of a gamepad. The data processing device implements the data processing method described in any one of the above embodiments. Herein, the data processing device may be assembled in a game host. With reference to FIG. 8, the data processing device in this embodiment includes a first acquiring module 81, a second acquiring module 82, a splitting module 83 and a transmission module 84.

Herein, the first acquiring module 81 is configured to acquire a configuration parameter of the gamepad. The configuration parameter includes an MTU value for communication with the gamepad. The second acquiring module 82 is configured to acquire a vibration signal to be transmitted. The splitting module 83 is configured to split the vibration signal to be transmitted into a plurality of sub-signals according to the configuration parameter, and generate a corresponding transmission time point for each of the plurality of sub-signals. Each of the plurality of sub-signals has a size not greater than the MTU value. The transmission module 84 is configured to transmit the plurality of sub-signals to the gamepad in sequence according to an order of transmission time points of the plurality of sub-signals.

Therefore, when the vibration signal to be transmitted is complicated (e.g., including a frequency curve), has a long duration, and has a size greater than the MTU value, based on the data processing device in the present disclosure, the vibration signal to be transmitted is split into a plurality of sub-signals, each of which has a size not greater than the MTU value. The plurality of sub-signals are transmitted one by one. This not only meets an MTU requirement of the gamepad, but an entire complicated vibration signal with a long duration can be transmitted to the gamepad, so that the gamepad can acquire diversified vibration effects, and a vibration sense with longer duration of vibration can be acquired, which improves vibration experience.

Herein, the second acquiring module 82 may specifically be configured to transmit a query instruction to the gamepad, and receive information carrying a configuration parameter returned by the gamepad according to the query instruction, so as to acquire configuration information of the gamepad.

Further, the splitting module 83 may specifically be configured to split the vibration signal to be transmitted into the plurality of sub-signals according to a rule that each of the plurality of sub-signals has a size not greater than the MTU value and a difference between the MTU value and the size of each of the plurality of sub-signals is less than a preset threshold. It should be understood that the less the preset threshold is set, the less the difference between the size of the respective sub-signal and the MTU value is, and the closer the size of the respective sub-signal is to the MTU value. Accordingly, in a case where a requirement for MTU is met, the size of the respective sub-signal may be as great as possible, so that the sub-signal may take as much part of the entire vibration signal to be transmitted as possible. In this way, the transmission efficiency can be improved.

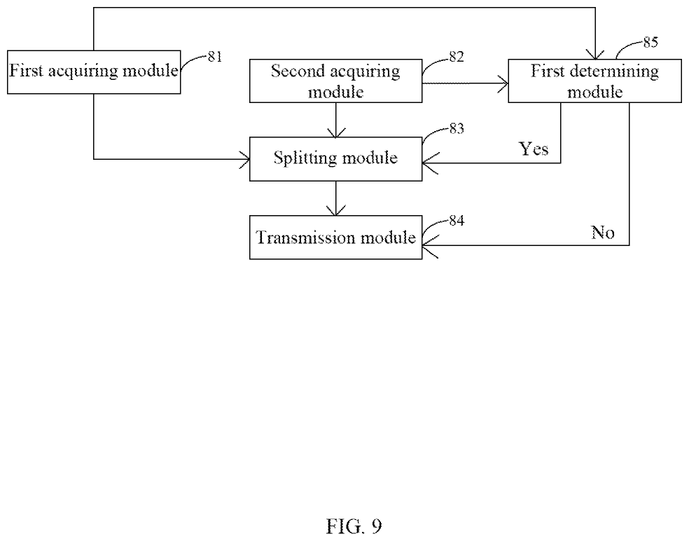

As shown in FIG. 9, further, the data processing device may include a first determining module 85 configured to determine whether the vibration signal has a size greater than the MTU value.

The splitting module 83 is configured to split the vibration signal to be transmitted into a plurality of sub-signals according to the configuration parameter when the first determining module 85 determines that the vibration signal to be transmitted has the size greater than the MTU value. The transmission module 85 is configured to directly transmit the vibration signal to be transmitted to the gamepad when the first determining module 85 determines that the vibration signal to be transmitted has a size not greater than the MTU value.

Accordingly, it is determined first whether the vibration signal to be transmitted has a size greater than the MTU value. If yes, the entire vibration signal to be transmitted may not be transmitted at a time, and thus the vibration signal to be transmitted is split. Otherwise, the entire vibration signal to be transmitted may be transmitted at a time. Therefore, the vibration signal to be transmitted is directly transmitted to the gamepad to improve transmission efficiency.

In some embodiments of the present disclosure, the configuration parameter further includes a cache capacity of the gamepad. The splitting module 83 is specifically configured to determine whether the vibration signal to be transmitted has a size greater than the cache capacity. If yes, a part of the vibration signal to be transmitted is removed so that a remaining part of the vibration signal to be transmitted has a size not greater than the cache capacity. The remaining part of the vibration signal to be transmitted is split into a plurality of sub-signals according to the MTU value. Herein, if the vibration signal to be transmitted has a size not greater than the cache capacity, it is not necessary to implement an action of removing the part of vibration signal to be transmitted, but the entire vibration signal to be transmitted is directly split into a plurality of sub-signals. Through this method, the entire vibration signal transmitted meets the cache requirement of the gamepad.

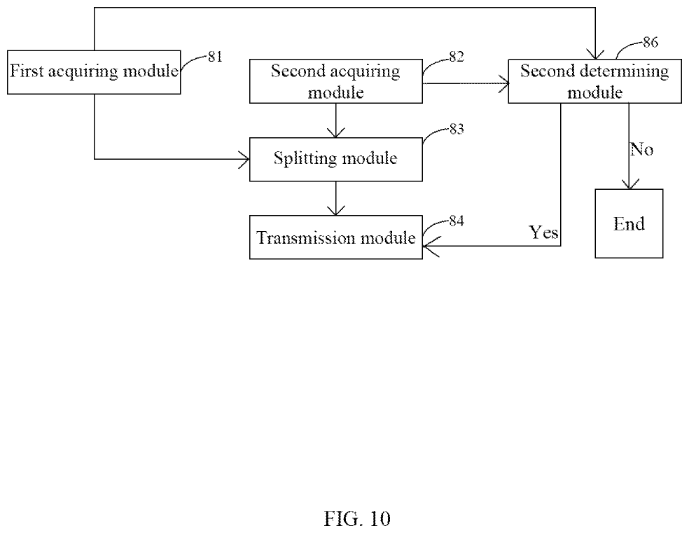

In some other embodiments of the present disclosure, as shown in FIG. 10, the gamepad may further include a second determining module 86. After the splitting module 83 splits the vibration signal to be transmitted into a plurality of sub-signals according to the configuration parameter and generates a corresponding transmission time point for each of the plurality of sub-signals, the second determining module 86 is configured to determine whether the vibration signal to be transmitted has a size greater than the cache capacity. When the second determining module 84 determines that the vibration signal to be transmitted has the size greater than the cache capacity, the transmission module 84 is configured to transmit an instruction of clearing cache to the gamepad at intervals with a preset duration during a process of transmitting the plurality of sub-signals to the gamepad.

In some other embodiments of the present disclosure, the configuration parameter further includes a signal format supported by the gamepad. The splitting module 83 may specifically be configured to determine whether a format of the vibration signal to be transmitted is consistent with the signal format supported by the gamepad. If the format of the vibration signal to be transmitted is not consistent with the signal format supported by the gamepad, the splitting module 83 is configured to convert the format of the vibration signal to be transmitted to the signal format supported by the gamepad. Then the splitting module 83 is configured to split a converted vibration signal to be transmitted into the plurality of sub-signals according to the MTU value. Herein, when the format of the vibration signal to be transmitted is consistent with the signal format supported by the gamepad, it is not necessary to perform conversion of the signal format. The vibration signal to be transmitted may directly be split into a plurality of sub-signals according to the MTU value.

An embodiment of the present disclosure further provides a game system including a gamepad and a data processing device in communicative connection with the gamepad. The data processing device is the data processing device described in any one of the above embodiments.

An embodiment of the present disclosure further provides a computer-readable storage medium storing a computer program. The computer program, when executed by a processor, implements operations of the data processing method of the gamepad described in any one of the above embodiments.

Compared with a related technology, in the data processing method of the gamepad of the present disclosure, the vibration signal to be transmitted is split into a plurality of sub-signals, and a corresponding transmission time point is generated for each of the plurality of sub-signals. Herein, each of the plurality of sub-signals has a size not greater than the MTU value for communication with the gamepad. Then, the plurality of sub-signals are transmitted to the gamepad in sequence according to an order of transmission time points of the plurality of sub-signals. In this way, a complicated (e.g., including a frequency curve) vibration signal with a long duration is split into a plurality of sub-signals and transmitted to the gamepad. This not only meets an MTU requirement of the gamepad, but an entire complicated vibration signal with a long duration can be transmitted to the gamepad, so that the gamepad can acquire diversified vibration effects, and a vibration sense with longer duration of vibration can be acquired, which improves vibration experience.

The above are only embodiments of the present disclosure. It shall be indicated that those of ordinary skill in the art can make improvements without departing from the creative concept of the present disclosure, and these belong to the protection scope of the present disclosure.

What is claimed is:

1. A data processing method of a gamepad, comprising:
acquiring a configuration parameter of the gamepad, the configuration parameter comprising a maximum transmission unit (MTU) value for communication with the gamepad;
acquiring a vibration signal to be transmitted;
splitting the vibration signal to be transmitted into a plurality of sub-signals according to the configuration parameter, and generating a corresponding transmission time point for each of the plurality of sub-signals, each of the plurality of sub-signals having a size not greater than the MTU value; and
transmitting the plurality of sub-signals to the gamepad in sequence according to an order of transmission time points of the plurality of sub-signals.

2. The data processing method according to claim 1, the operation of splitting the vibration signal to be transmitted into the plurality of sub-signals according to the configuration parameter comprising:
splitting the vibration signal to be transmitted into the plurality of sub-signals according to a rule that each of the plurality of sub-signals has a size not greater than the MTU value and a difference between the MTU value and the size of each of the plurality of sub-signals is less than a preset threshold.

3. The data processing method according to claim 1, further comprising:
determining, after acquiring the vibration signal to be transmitted, whether the vibration signal to be transmitted has a size greater than the MTU value; and
implementing the operation of splitting the vibration signal to be transmitted into the plurality of sub-signals according to the configuration parameter, in response to the vibration signal to be transmitted having the size greater than the MTU value.

4. The data processing method according to claim 1, the configuration parameter further comprising a cache capacity of the gamepad, and the operation of splitting the vibration signal to be transmitted into a plurality of sub-signals according to the configuration parameter comprising:
determining whether the vibration signal to be transmitted has a size greater than the cache capacity;
removing, in response to the vibration signal to be transmitted having the size greater than the cache capacity, a part of the vibration signal to be transmitted so that a remaining part of the vibration signal to be transmitted has a size not greater than the cache capacity; and
splitting the remaining part of the vibration signal to be transmitted into the plurality of sub-signals according to the MTU value.

5. The data processing method according to claim 1, the configuration parameter further comprising a cache capacity of the gamepad, and the data processing method further comprising:
determining, after acquiring the vibration signal to be transmitted, whether the vibration signal to be transmitted has a size greater than the cache capacity; and
transmitting an instruction of clearing cache to the gamepad at intervals with a preset duration during a process of transmitting the plurality of sub-signals to the gamepad, in response to the vibration signal to be transmitted having the size greater than the cache capacity.

6. The data processing method according to claim 1, the configuration parameter further comprising a signal format supported by the gamepad, and the operation of splitting the vibration signal to be transmitted into the plurality of sub-signals according to the configuration parameter comprising:
determining whether a format of the vibration signal to be transmitted is consistent with the signal format supported by the gamepad;
converting the format of the vibration signal to be transmitted to the signal format supported by the gamepad, in response to the format of the vibration signal to be transmitted being not consistent with the signal format supported by the gamepad; and
splitting a converted vibration signal to be transmitted into the plurality of sub-signals according to the MTU value.

7. The data processing method according to claim 1, the operation of acquiring the configuration parameter of the gamepad comprising:
transmitting a query instruction to the gamepad; and
receiving information carrying a configuration parameter returned by the gamepad according to the query instruction.

8. A game system, comprising a gamepad and a data processing device in communicative connection with the gamepad, wherein the data processing device comprises at least one processor and a storage medium storing:
a first acquiring module, configured to acquire a configuration parameter of the gamepad, the configuration parameter comprising a maximum transmission unit (MTU) value for communication with the gamepad;
a second acquiring module, configured to acquire a vibration signal to be transmitted;
a splitting module, configured to split the vibration signal to be transmitted into a plurality of sub-signals according to the configuration parameter, and generate a corresponding transmission time point for each of the plurality of sub-signals, each of the plurality of sub-signals having a size not greater than the MTU value; and
a transmission module, configured to transmit the plurality of sub-signals to the gamepad in sequence according to an order of transmission time points of the plurality of sub-signals.

9. The game system according to claim 8, wherein the splitting module is configured to split the vibration signal to be transmitted into the plurality of sub-signals according to a rule that each of the plurality of sub-signals has a size not greater than the MTU value and a difference between the MTU value and the size of each of the plurality of sub-signals is less than a preset threshold.

10. The game system according to claim 8, wherein the data processing device includes a first determining module configured to determine whether the vibration signal has a size greater than the MTU value;
the splitting module is configured to split the vibration signal to be transmitted into a plurality of sub-signals according to the configuration parameter in response to the first determining module determining that the vibration signal to be transmitted has the size greater than the MTU value.

11. The game system according to claim 8, wherein the configuration parameter further comprises a cache capacity of the gamepad;
the splitting module is configured to determine whether the vibration signal to be transmitted has a size greater than the cache capacity, remove, in response to the vibration signal to be transmitted having the size greater than the cache capacity, a part of the vibration signal to be transmitted so that a remaining part of the vibration signal to be transmitted has a size not greater than the cache capacity, and split the remaining part of the vibration signal to be transmitted into the plurality of sub-signals according to the MTU value.

12. The game system according to claim 8, wherein the configuration parameter further comprises a cache capacity of the gamepad; and the data processing device comprises a second determining module configured to determine whether the vibration signal to be transmitted has a size greater than the cache capacity;
the transmission module 84 is configured to transmit an instruction of clearing cache to the gamepad at intervals with a preset duration during a process of transmitting the plurality of sub-signals to the gamepad, in response to the second determining module determining that the vibration signal to be transmitted has the size greater than the cache capacity.

13. The game system according to claim 8, wherein the configuration parameter further comprises a signal format supported by the gamepad;
the splitting module is configured to determine whether a format of the vibration signal to be transmitted is consistent with the signal format supported by the gamepad, convert the format of the vibration signal to be transmitted to the signal format supported by the gamepad, in response to the format of the vibration signal to be transmitted being not consistent with the signal format supported by the gamepad, and split a converted vibration signal to be transmitted into the plurality of sub-signals according to the MTU value.

14. The game system according to claim 8, wherein the second acquiring module is configured to transmit a query instruction to the gamepad, and receive information carrying a configuration parameter returned by the gamepad according to the query instruction.

15. A non-transitory computer-readable storage medium storing a computer program that implements operations of a data processing method of a gamepad in response to the computer program being executed by a processor;
wherein the data processing method of the gamepad comprises:
acquiring a configuration parameter of the gamepad, the configuration parameter comprising a maximum transmission unit (MTU) value for communication with the gamepad;
acquiring a vibration signal to be transmitted;
splitting the vibration signal to be transmitted into a plurality of sub-signals according to the configuration parameter, and generating a corresponding transmission time point for each of the plurality of sub-signals, each of the plurality of sub-signals having a size not greater than the MTU value; and
transmitting the plurality of sub-signals to the gamepad in sequence according to an order of transmission time points of the plurality of sub-signals.
